(19) United States
(12) Patent Application Publication
(10) Pub. No.: US 2026/0210086 A1
(43) Pub. Date: Jul. 23, 2026

(54) WORK MACHINE AND CONTROL METHOD FOR WORK MACHINE

(71) Applicant: KOMATSU LTD., Minato-ku, Tokyo (JP)

(72) Inventor: Akira TAKENO, Minato-ku, Tokyo (JP)

(73) Assignee: KOMATSU LTD., Minato-ku, Tokyo (JP)

(21) Appl. No.: 19/139,989

(22) PCT Filed: Dec. 12, 2023
(86) PCT No.: PCT/JP2023/044380

§ 371 Date: Jun. 17, 2025

(30) Foreign Application Priority Data
Dec. 27, 2022 (JP) 2022-210154

(51) Int. Cl. E02F 9/20; B60T 7/22; B60T 8/171; B60T 8/172; B60T 13/68; B60T 17/22; E02F 9/22; E02F 9/26

(52) U.S. Cl. CPC E02F 9/2083; B60T 7/22; B60T 8/171; B60T 8/172; B60T 13/686; B60T 17/221; E02F 9/2033; E02F 9/261; B60T 2210/32; B60T 2250/00; E02F 9/2203; E02F 9/2253; E02F 9/2292; E02F 9/2296

(57) ABSTRACT

A wheel loader includes a traveling body that travels under power of an engine, brake circuits with a wet multi-plate disc structure that brake the traveling body, an EPC valve that controls operation of the brake circuits, and a controller that outputs an instruction current operating the EPC valve. The controller includes a calibration mode in which the controller outputs and calibrates the instruction current. The controller determines whether the traveling body is in a vehicle resting state, and executes the calibration mode when the traveling body is in the vehicle resting state.

### TECHNICAL FIELD

The present disclosure relates to a work machine and a control method for a work machine.

### BACKGROUND ART

Conventionally, in a wheel loader that is an example of a work machine, an automatic stop system that detects an obstacle behind the wheel loader and automatically stops the wheel loader has been proposed (for example, see Patent Document 1). Specifically, a wheel loader or the like uses a hydraulically driven brake to perform braking based on a command from a controller.

### CITATION LIST

### Patent Literature

Patent Document 1: JP 2022-150637 A

### SUMMARY OF INVENTION

### Technical Problem

In a brake of a wet-type multi-plate disc structure widely used in a work machine such as a wheel loader, a brake disc or the like wears due to deterioration over time, so the time or the like until braking of the brake starts to be effective changes. As described above, since the braking characteristics of the brake change due to the deterioration of the disc structure over time, the change of the hydraulic oil due to the environment, and the like, it is necessary to easily take measures to cope with the change.

An object of the present disclosure is to solve the above-described problem, and is to provide a work machine and a control method for a work machine capable of easily taking measures corresponding to a change in braking characteristics of a brake having a wet-type multi-plate disc structure.

### Solution to Problem

A work machine according to one aspect of the present disclosure includes: a traveling body configured to travel by power of a drive source; a brake circuit having a wet-type multi-plate disc structure configured to brake the traveling body; a control valve configured to control an operation of the brake circuit; and a controller configured to output a command current for operating the control valve. The controller has a calibration mode for outputting the command current and calibrating the command current. The controller is configured to determine whether the work machine is in a vehicle resting state and execute the calibration mode when the work machine is in the vehicle resting state.

A control method for a work machine according to one aspect of the present disclosure includes: a step of determining whether the work machine is in a vehicle resting state; a step of increasing a command current output to a control valve configured to control an operation of a brake circuit having a wet-type multi-plate disc structure configured to brake a traveling body when the work machine is in the vehicle resting state; a step of acquiring a pressure of a hydraulic oil supplied to the brake circuit; a step of determining whether the pressure of the hydraulic oil reaches a predetermined value based on an acquisition result; and a step of storing the command current when the pressure of the hydraulic oil reaches a predetermined value.

### Advantageous Effects of Invention

According to the present disclosure, it is possible to realize a work machine and a control method for a work machine capable of easily taking measures corresponding to a change in braking characteristics of a brake having a wet-type multi-plate disc structure.

### BRIEF DESCRIPTION OF DRAWINGS

FIG. 1 is a side view illustrating a configuration of a wheel loader 100 (an example of a work machine) according to an embodiment of the present disclosure.

FIG. 2 is a block diagram illustrating a braking system for the wheel loader of FIG. 1.

FIG. 3 is a hydraulic circuit diagram illustrating a configuration of the braking device of FIG. 2.

FIG. 4 is a diagram for explaining a structure of a brake circuit of FIG. 2.

FIG. 5 is a diagram for explaining an operation of the brake circuit of FIG. 2.

FIG. 6 is a block diagram illustrating a configuration of a controller illustrated in FIG. 2.

FIG. 7 is a flowchart illustrating a control operation of the wheel loader 100 according to the embodiment.

FIG. 8 is a diagram illustrating a state in which an object M is present behind the wheel loader 100 according to the embodiment.

FIG. 9 is a diagram illustrating various types of information in a case where automatic braking according to the embodiment is performed.

FIG. 10 is a diagram illustrating a relationship between a command current output to an EPC valve 46 and a pressure of a hydraulic oil supplied to a shuttle valve unit 47 according to the embodiment.

FIG. 11 is a flowchart of a calibration mode of the wheel loader 100 according to an embodiment.

FIG. 12 is a subroutine flowchart of a calibration process by a calibration processing unit 92 according to the embodiment.

FIG. 13 is a flowchart of another calibration mode of the wheel loader 100 according to an embodiment.

### DESCRIPTION OF EMBODIMENTS

Hereinafter, embodiments of the present disclosure will be described with reference to the drawings.

In the specification and the drawings, the same components or corresponding components are denoted by the same reference numerals, and redundant description will not be repeated. In the drawings, the configuration may be omitted or simplified for convenience of description. In addition, at least some of the embodiments and the modifications may be arbitrarily combined with each other.

### Configuration of Wheel Loader

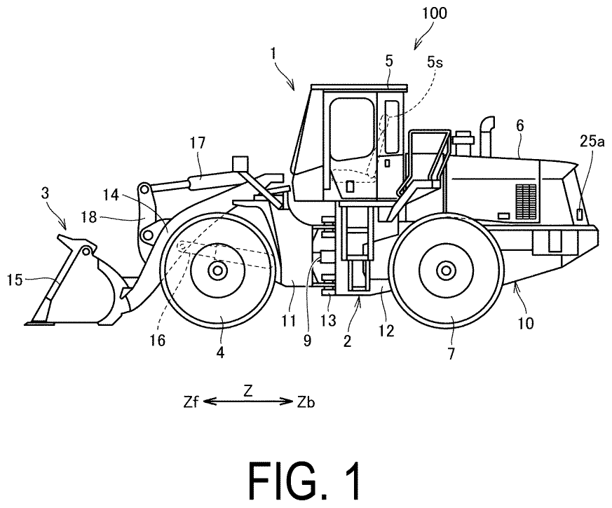

A configuration of a wheel loader 100 in the present embodiment will be described with reference to FIG. 1.

FIG. 1 is a side view illustrating a configuration of the wheel loader 100 (an example of a work machine) according to an embodiment of the present disclosure. As illustrated in FIG. 1, the wheel loader 100 in the present embodiment has a vehicle body 1 and an object sensor 25a. The vehicle body 1 includes a traveling body 2 and a work implement 3. The work implement 3 is disposed on the traveling body 2. The traveling body 2 includes a vehicle body frame 10, a pair of front tires 4, a cab 5, an engine room 6, a pair of rear tires 7, and a steering cylinder 9. The wheel loader 100 performs earth and sand loading work or the like using the work implement 3.

In the following description, “front”, “rear”, “right”, “left”, “up”, and “down” indicate directions based on a state in which an operator seated on an operator seat 5s in cab 5 looks forward. In FIG. 1, the frontward-rearward direction is indicated by Z, the frontward direction is indicated by Zf, and the rearward direction is indicated by Zb.

The vehicle body frame 10 is of a so-called articulated (swinging) type, and includes a front frame 11, a rear frame 12, and a coupling shaft portion 13. The front frame 11 is disposed in the frontward direction Zf of the rear frame 12. The coupling shaft portion 13 is provided at the center of the vehicle body frame 10 in the left-right direction (vehicle width direction), and swingably couples the front frame 11 and the rear frame 12 to each other. The pair of front tires 4 are attached to the left and right of the front frame 11. The pair of rear tires 7 are attached to the left and right of the rear frame 12.

The work implement 3 is driven by hydraulic oil from a work implement pump (not illustrated). The work implement 3 includes a boom 14, a bucket 15, a lift cylinder 16, a bucket cylinder 17, and a bell crank 18. The boom 14 is attached to front frame 11. The bucket 15 is attached to a distal end of the boom 14.

The lift cylinder 16 and the bucket cylinder 17 are hydraulic cylinders. One end of the lift cylinder 16 is attached to the front frame 11, and the other end of the lift cylinder 16 is attached to the boom 14. The boom 14 swings up and down by extension and contraction of the lift cylinder 16. One end of the bucket cylinder 17 is attached to the front frame 11, and the other end of the bucket cylinder 17 is attached to the bucket 15 via a bell crank 18. As the bucket cylinder 17 extends and contracts, the bucket 15 swings up and down.

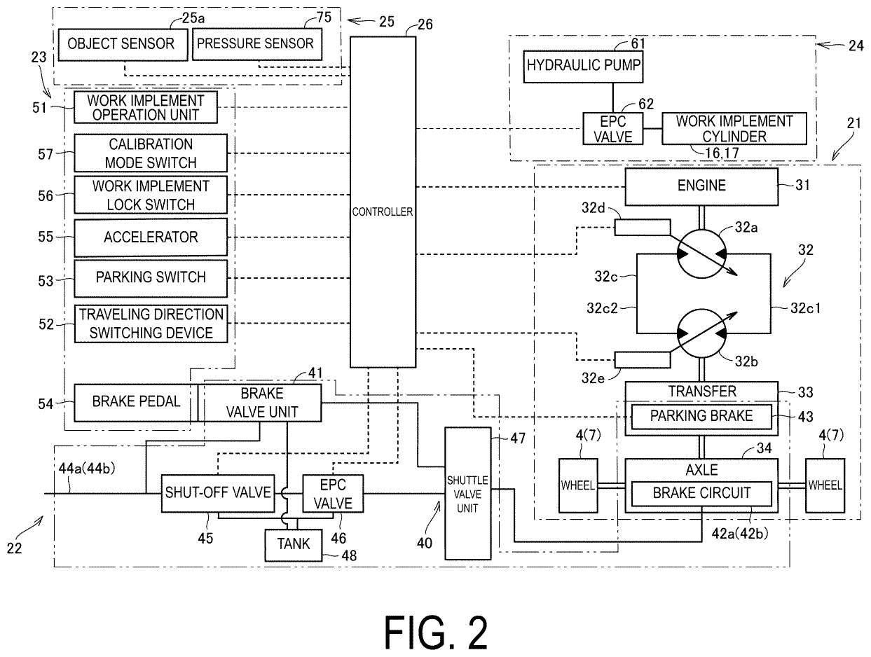

The cab 5 is placed on the rear frame 12. Inside the cab 5, the operator seat 5s for an operator to sit on, a steering wheel for steering operation, a lever for operating the work implement 3, various switches, a display, and the like are disposed. The engine room 6 is disposed on the rear frame 12 in the rearward direction Zb of the cab 5, and houses an engine 31 (FIG. 2).

### Braking System for Wheel Loader 100

Next, a braking system for the wheel loader 100 in the present embodiment will be described with reference to FIGS. 2 to 6.

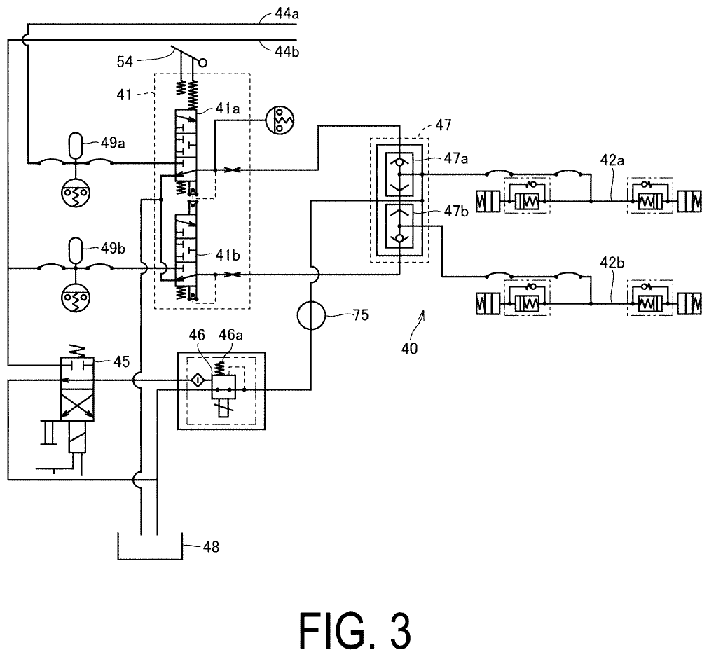

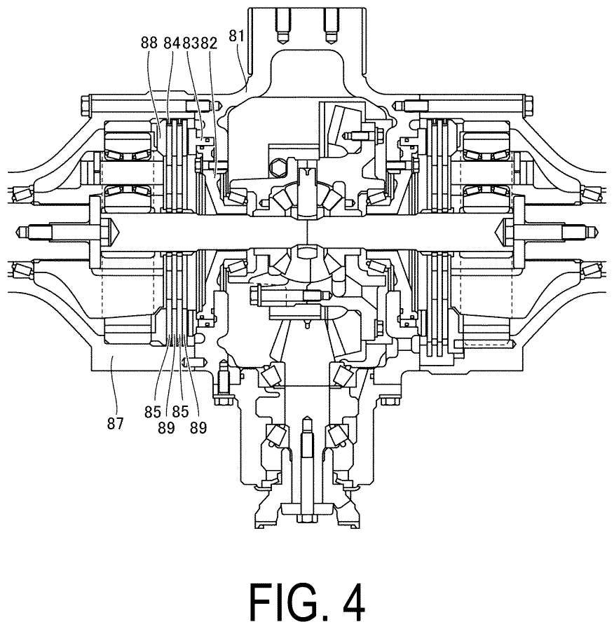

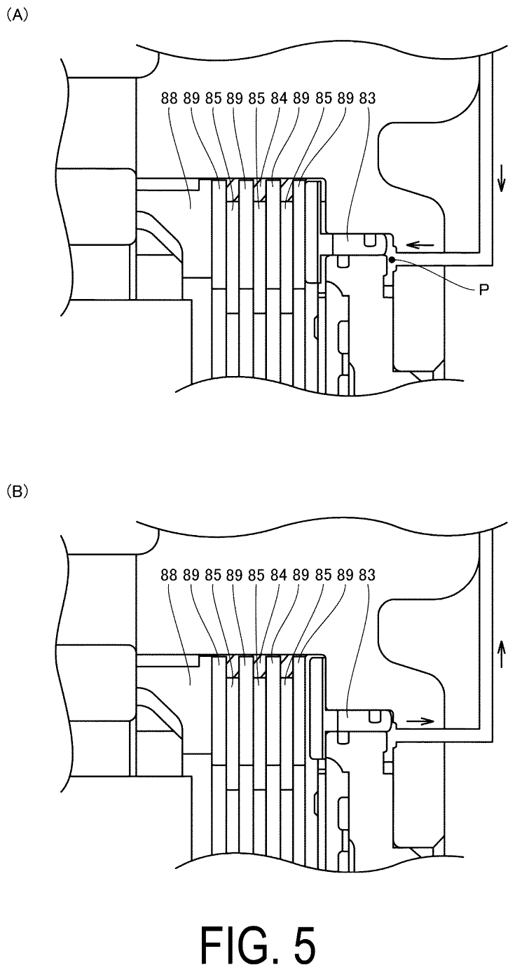

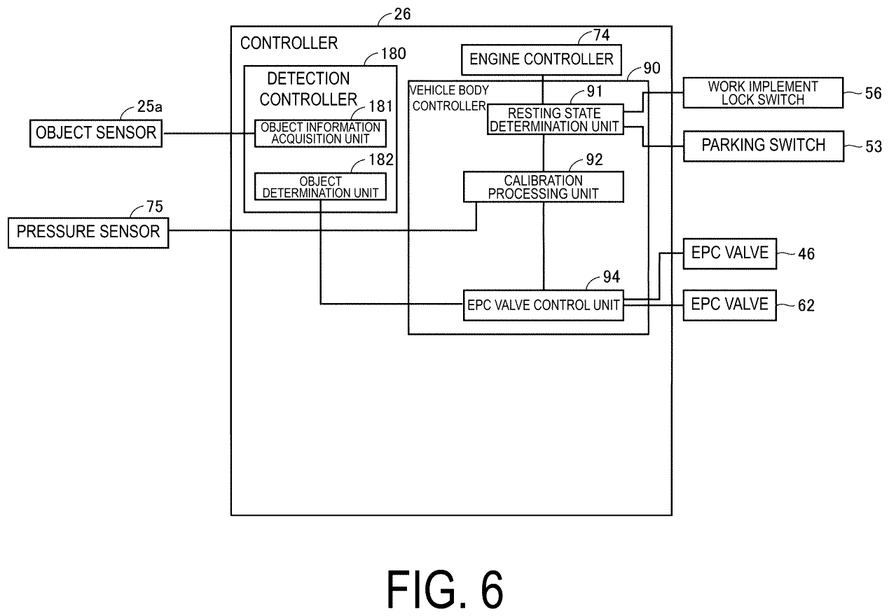

FIG. 2 is a block diagram illustrating the braking system for the wheel loader of FIG. 1. FIG. 3 is a hydraulic circuit diagram illustrating a configuration of the braking device of FIG. 2. FIG. 4 is a diagram for explaining a structure of a brake circuit of FIG. 2. FIG. 5 is a diagram for explaining the operation of the brake circuit of FIG. 2. FIG. 6 is a block diagram illustrating a configuration of a controller illustrated in FIG. 2.

As illustrated in FIG. 2, the braking system for the wheel loader 100 includes a drive device 21, a braking device 22, an operation device 23, an operation unit 24, a detection device 25, and a controller 26.

The drive device 21 drives the wheel loader 100. The braking device 22 brakes the wheel loader 100. The operation device 23 is operated by an operator. The operation unit 24 performs an operation of each of the work implement 3 and the steering. The detection device 25 detects an object (obstacle) or the like around the vehicle body 1. The controller 26 operates the drive device 21, the braking device 22, and the operation unit 24 based on the operation of the operator on the operation device 23 and the detection by the detection device 25.

### Drive Device 21

As illustrated in FIG. 2, the drive device 21 includes an engine 31, a HST 32, a transfer 33, an axle 34, the front tire 4, and the rear tire 7.

The engine 31 is, for example, a diesel engine, and a driving force generated by the engine 31 drives a pump 32a of a HST (Hydro Static Transmission) 32.

The HST 32 includes the pump 32a, a motor 32b, and a hydraulic circuit 32c. The pump 32a is, for example, a swash plate type variable displacement pump, and an angle of a swash plate can be changed by a solenoid 32d. The pump 32a is driven by the engine 31 to discharge the hydraulic oil. The discharged hydraulic oil is sent to the motor 32c through the hydraulic circuit 32b. The motor 32b is, for example, a swash plate type pump, and an angle of a swash plate can be changed by a solenoid 32e.

The hydraulic circuit 32c connects the pump 32a and the motor 32b. The hydraulic circuit 32c includes a first drive circuit 32c1 and a second drive circuit 32c2. When the hydraulic oil is supplied from the pump 32a to the motor 32b through the first drive circuit 32c1, the motor 32b is driven in one direction (for example, the forward direction). When the hydraulic oil is supplied from the pump 32a to the motor 32b through the second drive circuit 32c2, the motor 32b is driven in the other direction (for example, the reverse direction). The discharge direction of the hydraulic oil to the first drive circuit 32c1 or the second drive circuit 32c2 can be changed by the solenoid 32d.

The transfer 33 distributes the output from the engine 31 to the front and rear axles 34.

The pair of front tires 4 are connected to the front axle 34, and are rotated by the distributed output from the engine 31. The pair of rear tires 7 are connected to the rear axle 34, and are rotated by the distributed output from the engine 31.

### Braking Device 22

The braking device 22 includes a braking unit 40 and a shut-off valve 45. The braking unit 40 performs braking of the vehicle body 1 based on an operation of the brake pedal 54, and performs automatic braking control of the vehicle body 1 based on a command from the controller 26. The shut-off valve 45 brings the braking unit 40 into a state in which the braking force by the automatic braking control can be exerted or cannot be exerted.

The braking unit 40 includes a brake valve unit 41, brake circuits 42a and 42b (an example of a service brake), a parking brake 43, hydraulic oil supply passages 44a and 44b, an EPC (Electric Proportional Valve) 46, a shuttle valve unit 47, and a tank 48.

Accumulators, pumps, and the like are connected to the hydraulic oil supply passages 44a and 44b, and the hydraulic oil is supplied.

As illustrated in FIG. 3, the brake valve unit 41 is operated by a brake pedal 54 to be described later. The brake valve unit 41 includes a rear brake valve 41a and a front brake valve 41b. Each of the rear brake valve 41a and the front brake valve 41b is a three position directional control valve having three ports.

The first port of the rear brake valve 41a is connected to the hydraulic oil supply passage 44a via the accumulator 49a. A second port of the rear brake valve 41a is connected to the tank 48. The third port of the rear brake valve 41a is connected to the rear shuttle valve 47a of the shuttle valve unit 47.

In the first state, the rear brake valve 41a connects the first port and the third port, connects the hydraulic oil supply passage 44a and the rear shuttle valve 47a, and supplies the hydraulic oil to the rear shuttle valve 47a. In the second state, the rear brake valve 41a closes all the ports. In the third state, the rear brake valve 41a connects the second port and the third port, and discharges the hydraulic oil between the rear shuttle valve 47a and the rear brake valve 41a to the tank 48. In the second state and the third state, the rear brake valve 41a stops the supply of the hydraulic oil to the rear shuttle valve 47a.

The first port of the front brake valve 41b is connected to the hydraulic oil supply passage 44b via the accumulator 49b. The second port of the front brake valve 41b is connected to the tank 48. The third port of the front brake valve 41b is connected to the front shuttle valve 47b of the shuttle valve unit 47.

In the first state, the front brake valve 41b connects the first port and the third port, connects the hydraulic oil supply passage 44b and the front shuttle valve 47b, and supplies the hydraulic oil to the front shuttle valve 47b. The front brake valve 41b closes all the ports in the second state. In the third state, the front brake valve 41b connects the second port and the third port, and discharges the hydraulic oil between the front shuttle valve 47b and the front brake valve 41b to the tank 48. The front brake valve 41b stops the supply of the hydraulic oil to the front shuttle valve 47b in the second state and the third state.

The opening degrees of the rear brake valve 41a and the front brake valve 41b are adjusted in accordance with the operation amount of the brake pedal 54, and the amount of hydraulic oil supplied to the shuttle valve unit 47 is changed. For example, when the operation amount of the brake pedal 54 is large, the amount of the hydraulic oil supplied from the rear brake valve 41a and the front brake valve 41b to the shuttle valve unit 47 increases.

The brake circuit 42a is provided on the rear axle 34 (FIG. 2). The brake circuit 42a is connected to the rear shuttle valve 47a. The brake circuit 42b is provided on the front axle 34 (FIG. 2). The brake circuit 42b is connected to the front shuttle valve 47b.

The brake circuits 42a and 42b are hydraulic brakes. The braking force of the brake circuit 42a increases as the amount or pressure of the hydraulic oil supplied from the rear shuttle valve 47a increases. The braking force of the brake circuit 42b increases as the amount or pressure of the hydraulic oil supplied from the front shuttle valve 47b increases.

The shut-off valve 45 is connected to the hydraulic oil supply passage 44b. The shut-off valve 45 is a solenoid valve having four ports and taking two states of an open state and a closed state. A first port of the shut-off valve 45 is connected to the hydraulic oil supply passage 44b. A second port of the shut-off valve 45 is connected to the tank 48. A third port of the shut-off valve 45 is connected to the EPC valve 46. A fourth port of the shut-off valve 45 allows air to pass therethrough in an open state, and is blocked in a closed state.

The shut-off valve 45 is opened and closed based on an instruction from the controller 26. Specifically, the shut-off valve 45 enters an open state when energized by an open command from the controller 26, and enters a closed state when de-energized by a close command from the controller 26.

In the open state, the shut-off valve 45 connects the first port and the third port, and supplies the hydraulic oil from the hydraulic oil supply passage 44b to the EPC valve 46.

Further, in the open state, the shut-off valve 45 connects the fourth port through which air passes and the second port connected to the tank 48.

In the closed state, the shut-off valve 45 connects the second port and the third port, and discharges the hydraulic oil between the shut-off valve 45 and the EPC valve 46 to the tank 48. In the closed state, the shut-off valve 45 closes the first port and the fourth port. Thus, in the closed state, the shut-off valve 45 stops the supply of the hydraulic oil from the hydraulic oil supply passage 44b to the EPC valve 46.

In the present embodiment, the controller 26 brings the shut-off valve 45 into the open state only when the vehicle body 1 is traveling backward, for example. The backward movement of the vehicle body 1 is determined by the controller 26 based on the signal indicating the lever position in a traveling direction switching device 52 and the opening degree signal indicating the accelerator operation amount of an accelerator 55.

The EPC valve 46 is disposed in a flow path connecting the shut-off valve 45 and the shuttle valve unit 47. The EPC valve 46 is a solenoid valve having three ports. A first port of the EPC valve 46 is connected to the shut-off valve 45. A second port of the EPC valve 46 is connected to the tank 48. A third port of the EPC valve 46 is connected to the shuttle valve unit 47.

In the open state, the EPC valve 46 connects the first port and the third port and supplies the hydraulic oil supplied from the shut-off valve 45 to the shuttle valve unit 47. The opening degree of the EPC valve 46 is adjusted based on an instruction from the controller 26. By adjusting the opening degree of the EPC valve 46, the amount of hydraulic oil supplied to the shuttle valve unit 47 is changed.

When the EPC valve 46 is in the closed state, the first port is closed, the second port and the third port are connected, and the hydraulic oil in the flow path from the EPC valve 46 to the shuttle valve unit 47 is discharged to the tank 48. Accordingly, in the closed state, the EPC valve 46 stops the supply of the hydraulic oil from the shut-off valve 45 to the shuttle valve unit 47.

In the present embodiment, the controller 26 controls the EPC valve 46 to the open state when the wheel loader 100 travels in a predetermined direction (for example, the rearward direction Zb) and it is determined that the risk of collision with an object in the traveling direction is high.

The shuttle valve unit 47 includes the rear shuttle valve 47a and the front shuttle valve 47b. The rear shuttle valve 47a supplies, to the brake circuit 42a, the hydraulic oil having a higher pressure between the hydraulic oil supplied via the rear brake valve 41a and the hydraulic oil supplied via the EPC valve 46. The front shuttle valve 47b supplies, to the brake circuit 42b, the hydraulic oil having a higher pressure between the hydraulic oil supplied via the front brake valve 41b and the hydraulic oil supplied via the EPC valve 46.

With such a configuration, even when the brake pedal 54 is not operated and the hydraulic oil is not supplied from the brake valve unit 41, the hydraulic oil is supplied from the rear shuttle valve 47a and the front shuttle valve 47b to the brake circuits 42a and 42b and the automatic braking control is performed when the shut-off valve 45 and the EPC valve 46 are opened by the instruction from the controller 26. The brake that is switched between the braking state and the non-braking state by the brake circuits 42a and 42b is, for example, a wet multi-plate disc brake.

As illustrated in FIG. 4, in this example, the structure of the brake circuit 42a provided at the rear is illustrated.

The wet multi-plate disc brake mainly includes a plurality of discs 89, a plate 85, a piston 83), an end plate 88, and a spring 84. The brake cylinder consists of a differential housing 81 and a bearing carrier 82, in which a piston 83 is integrated. The plate 85 and the end plate 88 are coupled to a spline portion of the axle housing 87.

Each of the plurality of discs 89 is fixed to an output shaft to the rear tire 7 by a spline portion. The plates 85 are interleaved with the discs 89 and are non-rotatably fixed to the axle housing 87 by spline portions. The piston 83 is actuated by the oil pressure of the hydraulic oil supplied to the brake circuit 42a. Although the structure of the brake circuit 42a provided at the rear has been described, the structure of the wet multi-plate disc brake is the same as that of the brake circuit 42b provided in the front tire 4.

As illustrated in FIG. 5(A), when the hydraulic oil is supplied to the brake circuits 42a and 42b and enters the oil passage in the brake cylinder, the piston 83 is actuated toward the disc 89 by the oil pressure P of the hydraulic oil in the brake cylinder, whereby the plate 85 is sandwiched and pressed between the plurality of discs 89. As a result, the wet multi-plate disc brake is operated to be in a braking state.

As illustrated in FIG. 5(B), when the supply of the hydraulic oil to the brake circuits 42a and 42b is stopped, the piston 83 returns to the original position by the repulsive force (restoring force) of the spring 84, and the pressed state between the plate 85 and the disc 89 is released. As a result, the wet multi-plate disc brake is brought into a non-braking state.

As illustrated in FIG. 2, the parking brake 43 is provided in the transfer 33. As the parking brake 43, for example, a wet multi-stage brake capable of switching between a braking state and a non-braking state, a disc brake, or the like can be used.

### Operation Device 23

The operation device 23 is operated by an operator in the cab 5 (FIG. 1). The operation device 23 includes a work implement operation unit 51, a traveling direction switching device 52, a parking switch 53, a brake pedal 54, an accelerator 55, a work implement lock switch 56, and a calibration mode switch 57.

The work implement operation unit 51 is provided in the cab 5. The work implement operation unit 51 operates an operation of the work implement 3, and is, for example, an operation lever operated by an operator. The operation amount of the work implement operation unit 51 is detected by, for example, a potentiometer, a Hall IC (Integrated Circuit), or the like. When the work implement operation unit 51 is operated, an operation signal indicating an operation amount of the work implement operation unit 51 is transmitted to the controller 26. The controller 26 transmits the operation signal as an operation command to the EPC valve 62 for the lift cylinder 16 and the bucket cylinder 17.

The traveling direction switching device 52 is provided in the cab 5. The operator operates the traveling direction switching device 52 to set the traveling direction of the wheel loader 100. The traveling direction switching device 52 is, for example, an FNR lever. The FNR lever can take a lever position of forward (F), neutral (N), or reverse (R). An operation signal indicating the lever position of the FNR lever is transmitted to the controller 26, and the controller 26 switches the traveling direction to forward, neutral, or reverse by controlling the solenoid 32d.

As a position detection sensor that detects the lever position of the FNR lever, a potentiometer may be used, or a switch may be provided for each of the forward drive position, the reverse drive position, and the neutral position. Further, both the potentiometer and the switch may be provided so as to be able to detect an erroneous operation even if one of the potentiometer and the switch is erroneously operated.

The brake pedal 54 is provided in the cab 5. The brake pedal 54 adjusts the opening degrees of the rear brake valve 41a and the front brake valve 41b of the brake valve unit 41.

The accelerator 55 is provided in the cab 5. The operator operates the accelerator 55 to set the throttle opening degree. The accelerator 55 generates an opening degree signal indicating an accelerator operation amount and transmits the opening degree signal to the controller 26. The controller 26 controls the rotational speed of the engine 31 based on the transmitted signal.

The parking switch 53 is provided in the cab 5, is a switch whose state can be switched between on and off, and transmits a signal indicating the state to the controller 26. The controller 26 puts the parking brake 43 into a braking state or a non-braking state based on the transmitted signal.

The work implement lock switch 56 is provided in the cab 5, is a switch whose state can be switched between on and off, and transmits a signal indicating the state to the controller 26. The controller 26 invalidates the operation signal for operating the operation of the work implement 3 based on the transmitted signal. For example, when the work implement lock switch 56 is on, the controller 26 outputs a close command to the EPC valve 62 for the lift cylinder 16 and the bucket cylinder 17. As a result, the EPC valve 62 is closed, and the work implement 3 cannot be operated.

The calibration mode switch 57 is provided in the cab 5, is a switch whose state can be switched between on and off, and transmits a signal indicating the state to the controller 26. The controller 26 starts execution of a manual calibration mode described later based on the transmitted signal.

### Detection Device 25

The detection device 25 includes an object sensor 25a and a pressure sensor 75.

The object sensor 25a detects an object (obstacle) in the surroundings of the vehicle body 1. The object sensor 25a detects an object located in the traveling direction of the wheel loader 100. To be specific, the object sensor 25a is a rear detection unit that detects an object in the rearward direction Zb of the vehicle body 1 when the wheel loader 100 travels in the rearward direction Zb. The object sensor 25a is a front detection unit that detects an object in the frontward direction Zf of the vehicle body 1 when the wheel loader 100 travels in the frontward direction Zf.

When the object sensor 25a is a rear detection unit, the rear detection unit is attached to, for example, the rear end of the vehicle body 1 as illustrated in FIG. 1, but may be attached to a position other than the rear end. When the object sensor 25a is the front detection unit, the front detection unit may be attached to, for example, the cab 5, may be attached to the front frame 11, or may be attached to other components.

The object sensor 25a is, for example, a LiDAR (Light Detection and Ranging) that emits laser light to acquire information on an object. The object sensor 25a may be a Radar (Radio Detection and Ranging) that acquires information on a target object by emitting radio waves. The radar may be, for example, a millimeter-wave radar that uses a reception antenna to detect a state in which a radio wave in a millimeter-wave band emitted from a transmission antenna is reflected by a surface of an object and returns. The object sensor 25a may be a visual sensor including a camera. The object sensor 25a may be an infrared sensor.

Information detected by the object sensor 25a is transmitted to the controller 26, and the controller 26 determines whether an object is present in the traveling direction of the vehicle body 1. Further, the controller 26 calculates a distance to the detected object. The controller 26 may determine whether the risk of the vehicle body 1 colliding with the object is high based on the distance to the detected object or the like.

As illustrated in FIG. 3, the pressure sensor 75 detects the hydraulic pressure in the hydraulic circuit between the EPC valve 46 and the shuttle valve unit 47. In this example, the pressure sensor 75 detects the pressure of the hydraulic oil supplied to the shuttle valve unit 47.

As illustrated in FIG. 2, the information detected by the pressure sensor 75 is transmitted to the controller 26, and the controller 26 executes a calibration process based on the information in the calibration mode.

### Operation Unit 24

The operation unit 24 includes the lift cylinder 16, the bucket cylinder 17, the EPC valve 62, and the hydraulic pump 61. A part of the driving force of the engine 31 is transmitted to the hydraulic pump 61. The hydraulic pump 61 is driven by the engine, and operates the lift cylinder 16 and the bucket cylinder 17 by the discharged hydraulic oil. The hydraulic oil discharged from the hydraulic pump 61 is supplied to the lift cylinder 16 and the bucket cylinder 17 via the EPC valve 62.

The EPC valve 62 is opened and closed based on an instruction from the controller 26. Specifically, the EPC valve 62 enters an open state when energized by an open command from the controller 26, and enters a closed state when de-energized by a close command from the controller 26.

In the open state, the EPC valve 62 connects the hydraulic pump 61 to the lift cylinder 16 and the bucket cylinder 17, and supplies the hydraulic oil from the hydraulic pump 61 to the lift cylinder 16 and the bucket cylinder 17. In the closed state, the EPC valve 62 stops the supply of the hydraulic oil from the hydraulic pump 61 to the lift cylinder 16 and the bucket cylinder 17.

### Controller 26

The controller 26 includes a processor, a main memory, and a storage. The processor is, for example, a CPU (Central Processing Unit). The main memory includes, for example, a nonvolatile memory such as a ROM (Read Only Memory) and a volatile memory such as a RAM (Random Access Memory).

Each of the controller 26 and the operation device 23 may be mounted on the wheel loader 100, or may be disposed outside and away from the wheel loader 100. when each of the controller 26 and the operation device 23 is disposed outside and away from wheel loader 100, each of the controller 26 and the operation device 23 may be wirelessly connected to the drive device 21, the braking device 22, the operation device 23, the detection device 25, and the like. The controller 26 may be stored in a server remote from the wheel loader 100. In addition, since the operation device 23 is separated from the wheel loader 100, the operator may remotely operate the wheel loader 100 without getting in the cab 5 of the wheel loader 100.

The controller 26 reads a program stored in the storage, expands the program in the main memory, and executes a predetermined process according to the program. The controller 26 may be divided into a collision detection controller and an HST controller. The collision detection controller and the HST controller may have different CPUs. Alternatively, the program may be distributed to the controller 26 via a network.

As illustrated in FIG. 6, the controller 26 includes, for example, a detection controller 180, a vehicle body controller 90, and an engine controller 74.

Each of the detection controller 180, the vehicle body controller 90, and the engine controller 74 includes a processor such as a CPU (Central Processing Unit), a main memory including a non-volatile memory such as a ROM (Read Only Memory) and a volatile memory such as a RAM (Random Access Memory), and a storage.

The detection controller 180, the vehicle body controller 90, and the engine controller 74 read a program stored in the storage, expand the program in the main memory, and execute predetermined processing in accordance with the program. In the embodiment, it is described that each of the detection controller 180, the vehicle body controller 90, and the engine controller 74 has a CPU, but the detection controller 180, the vehicle body controller 90, and the engine controller 74 may have one CPU as a whole. Further, the program may be distributed to the detection controller 180, the vehicle body controller 90, and the engine controller 74 via a network.

The engine controller 74 controls the state of the engine 31 (FIG. 2). Specifically, the rotational speed of the engine 31 is controlled. The engine controller 74 notifies a resting state determination unit 91 of the vehicle body controller 90, which will be described later, of the operation state of the engine 31. For example, the engine controller 74 notifies the resting state determination unit 91 of an operating state in which work is being performed and a resting state in which the work is stopped as the operation state of the engine 31.

The detection controller 180 detects the presence of an object based on information detected at the object sensor 25a.

The vehicle body controller 90 controls the automatic brake based on the detection result of the detection controller 180.

The detection controller 180 includes an object information acquisition unit 181 and an object determination unit 182.

The object information acquisition unit 181 acquires information regarding the rear side detected by the object sensor 25a. The object determination unit 182 determines whether an object is present on the rear side based on the acquired information regarding the rear side. The determination result by the object determination unit 182 is transmitted to the EPC valve control unit 94 described later.

The vehicle body controller 90 includes the resting state determination unit 91, the calibration processing unit 92, and the EPC valve control unit 94.

In the embodiment, the control of the automatic brake is performed when an object is detected on the rear side at the time of backward movement. For example, even in a stopped state where the front tire 4 and the rear tire 7 are not rotating, it may be determined that the vehicle body 1 is in the backward traveling state when the traveling direction switching device 52 is in the backward traveling position.

When it is determined that the vehicle body 1 is moving backward and the object determination unit 182 determines that an object is present behind the vehicle body 1, the EPC valve control unit 94 outputs a command current serving as an open command to the EPC valve 46. The opening degree of the EPC valve 46 is adjusted by a command current. In this example, it is set to be a predetermined value (Is described later) in advance. The adjustment may be performed based on the distance to the detected object. For example, the deceleration at which the vehicle stops in front of the object may be calculated from the distance to the detected object, and the EPC valve control unit 94 may transmit an open command (command current) to the EPC valve 46 so as to achieve an opening degree at which the deceleration is exhibited.

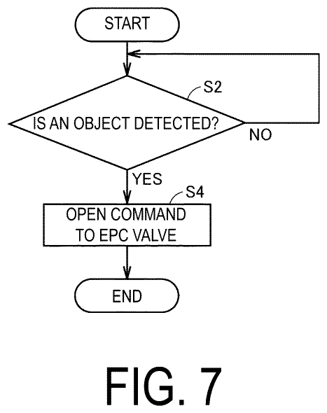

The solenoid of the EPC valve 46 is operated based on the open command (command current) to be in the open state, and the hydraulic oil is supplied from the EPC valve 46 to the rear shuttle valve 47a and the front shuttle valve 47b. In the rear shuttle valve 47a, one of the hydraulic oil from the rear brake valve 41a and the hydraulic oil from the EPC valve 46, which has a higher pressure, is supplied to the brake circuit 42a to exert a braking force. Further, in the front shuttle valve 47b, one of the hydraulic oil from the front brake valve 41b and the hydraulic oil from the EPC valve 46, which has a higher pressure, is supplied to the brake circuit 42a to exert a braking force. As a result, even when the brake pedal 54 is not operated by the operator, the automatic braking is performed and the braking force is exerted. As illustrated in FIG. 7 described later, the vehicle body 1 can be stopped in front of the object M. The vehicle body 1 in a stopped state is indicated by a two dot chain line.

Even when the braking force by the automatic brake is not exerted, the brake circuits 42a and 42b are operated when the operator operates the brake pedal 54 and the hydraulic oil is supplied from the brake valve unit 41 to the shuttle valve unit 47.

The resting state determination unit 91 determines whether the wheel loader 100 is in the vehicle resting state. Specifically, the resting state determination unit 91 determines whether it is the vehicle resting state based on the operation state of the engine from the engine controller 74, the state of the work implement lock switch 56, and the state of the parking switch 53. For example, the resting state determination unit 91 determines that it is the vehicle resting state based on the operation state of the engine from the engine controller 74 being the resting state, the state of the work implement lock switch 56 being the ON state, and the state of the parking switch being the ON state.

The calibration processing unit 92 executes the calibration mode when it is the vehicle resting state based on the determination result of the resting state determination unit 91. The calibration mode is a process of calibrating a command current serving as an open command for the EPC valve 46 based on the detection result of the pressure sensor 75. The calibration mode in the calibration processing unit 92 will be described later.

### Operation

Next, a control operation of the wheel loader 100 according to the embodiment will be described.

FIG. 7 is a flowchart illustrating a control operation of the wheel loader 100 according to the embodiment. As illustrated in FIG. 6, the object determination unit 182 determines whether an object is present behind the vehicle body 1 (step S2: FIG. 7).

Next, in step S2, when the object determination unit 182 determines that an object is present behind the vehicle body 1 (YES in step S2), the EPC valve control unit 94 transmits an open command (command current) to the EPC valve 46 (step S4: FIG. 7). As a result, the solenoid of the EPC valve 46 is operated to open the EPC valve 46, and the hydraulic oil is supplied from the EPC valve 46 to the brake circuits 42a and 42b via the rear shuttle valve 47a and the front shuttle valve 47b, so that the braking force by the automatic brake is exerted.

Then, the process is terminated (END: FIG. 7).

On the other hand, in step S2, when the object determination unit 182 determines that there is no object behind the vehicle body 1 (NO in step S2), the state of step S2 is maintained.

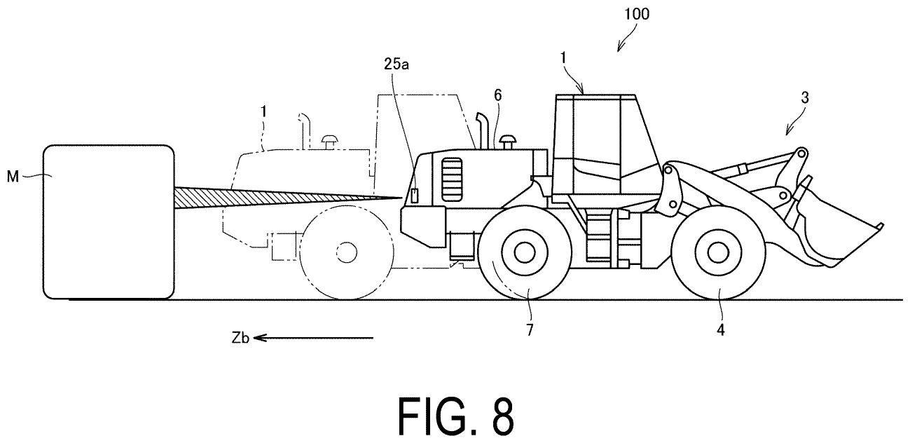

FIG. 8 is a diagram illustrating a state in which an object M is present behind the wheel loader 100 according to the embodiment. As illustrated in FIG. 8, in a state where the vehicle body 1 is traveling rearward, when the object M is detected rearward, the vehicle body 1 can be stopped in front of the object M by the automatic brake.

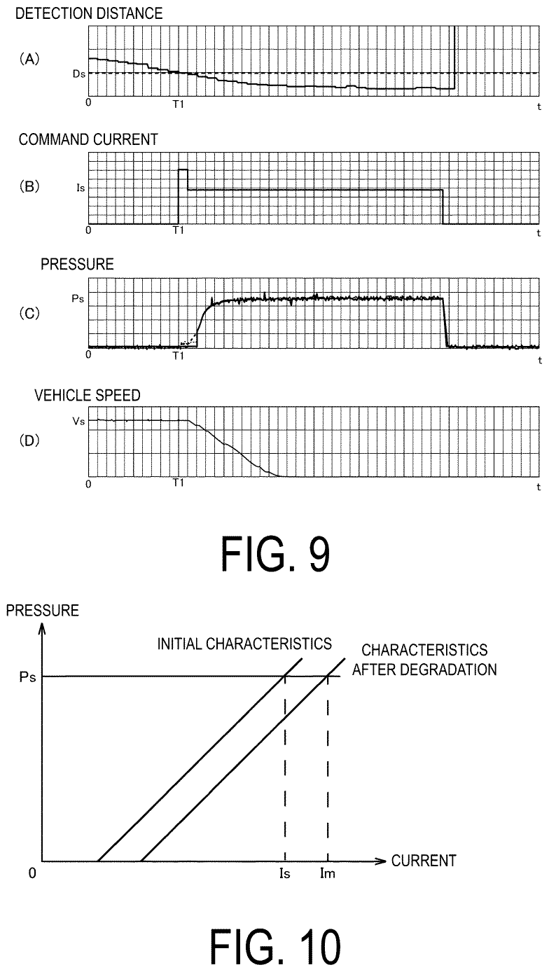

FIG. 9 is a diagram illustrating various types of information in a case where automatic braking according to the embodiment is performed.

FIG. 9(A) illustrates detection distances between the object M detected by the object sensor 25a and the vehicle body 1. In this example, the braking operation is started when the distance between the vehicle body 1 and the object M becomes Ds. To be more specific, a case is illustrated in which the distance between the vehicle body 1 and the object M becomes Ds at a time T1.

FIG. 9(B) illustrates the command current Is for controlling the EPC valve 46. To be specific, there is illustrated a case where the command current is controlled by feed forward so as to become Is after the time T1.

FIG. 9(C) illustrates the pressure of the hydraulic oil supplied to the shuttle valve unit 47. In this example, the pressure of the hydraulic oil is controlled to Ps with respect to the command current Is. Automatic brake control is performed by the brake circuits 42a and 42b in accordance with the hydraulic oil supplied to the shuttle valve unit 47.

FIG. 9(D) illustrates the vehicle speed of vehicle body 1. In this example, a case is illustrated where, in a state where the vehicle body 1 is traveling backward at a vehicle speed Vs, the vehicle speed is gradually reduced by the control of the automatic brake and the vehicle body 1 stops.

### Calibration Mode

FIG. 10 is a diagram illustrating a relationship between the command current output to the EPC valve 46 and the pressure of the hydraulic oil supplied to the shuttle valve unit 47 according to the embodiment.

As illustrated in FIG. 10, the braking characteristic of the brake changes due to the deterioration of the disc structure over time, the change of the hydraulic oil due to the environment, and the like. That is, the pressure of the hydraulic oil with respect to a command current value fluctuates due to deterioration of the disc structure over time or the like.

Specifically, in the brake having the wet-type multi-plate disc structure illustrated in FIGS. 4 and 5, a gap between the plate 85 and the disc 89 increases as the brake disc or the like wears due to deterioration over time.

For this reason, as illustrated in FIG. 10, in order to obtain the same pressure Ps of the hydraulic oil as the initial pressure after deterioration over time, it is necessary to output a command current Im larger than the initial command current Is to the EPC valve 46. Therefore, it is necessary to calibrate the command current so that a measure corresponding to the change in the braking characteristic of the brake having the wet-type multi-plate disc structure can be easily taken.

Further, the spring characteristics of the return spring 46a in the EPC valve 46 illustrated in FIG. 3 change in the initial operation (for example, about 100 hours). When the spring characteristic of the return spring 46a changes, the pressure of the hydraulic oil supplied to the brake circuits 42a and 42b through the EPC valve 46 changes. It is therefore necessary to calibrate the command current so as to be able to easily take measures corresponding to a change in the braking characteristics of the brake.

In this regard, in the calibration mode in the embodiment, the command current is increased and the command current at which the pressure of the hydraulic oil supplied to the shuttle valve unit 47 becomes Ps is detected. By repeatedly executing the calibration mode, it is possible to easily take measures corresponding to a change in the braking characteristics of the brake of the wet-type multi-plate disc structure.

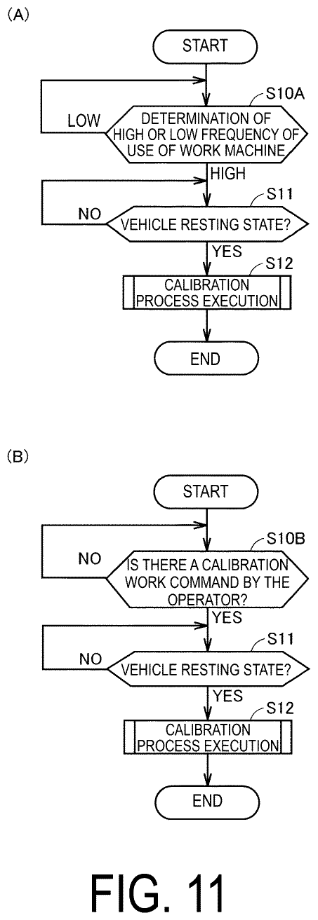

FIG. 11(A) and 11(B) are flowcharts of the calibration mode of the wheel loader 100 according to the embodiment. FIG. 11(A) illustrates a flowchart of automatic calibration, and FIG. 11(B) illustrates a flowchart of manual calibration. The automatic calibration refers to calibration performed based on a calibration work command issued from the controller 26 itself. The manual calibration refers to calibration performed based on a calibration work command input by an operator.

As illustrated in FIG. 11(A), in the automatic calibration, it is determined whether the use frequency of the work machine is high or low. As the determination of whether the use frequency is high or low, for example, it is determined whether a predetermined time has elapsed from the previous calibration work (step S10A). The predetermined time may be set to, for example, 100 hours. In addition, as the determination of the use frequency, it may be determined whether the use frequency (the number of times of use) of the brake is equal to or greater than a predetermined number of times. The determination of whether the use frequency is high or low is executed by the calibration processing unit 92 (FIG. 6). In this determination, when it is determined that the frequency of use is low (for example, a predetermined time has not elapsed from the previous calibration, or the number of uses of the brake is less than a predetermined number), the determination of step S10A is repeated. On the other hand, when it is determined in this determination that the use frequency is high (for example, a predetermined time has elapsed from the previous calibration, or the number of times of use of the brake is equal to or more than a predetermined number of times), the resting state determination unit 91 determines whether the wheel loader 100 is in the vehicle resting state (step S11). The resting state determination unit 91 determines that it is the vehicle resting state based on the operation state of the engine from the engine controller 74 being the operating state, the state of the work implement lock switch 56 being the ON state, and the state of the parking switch being the ON state.

Next, in step S11, when the resting state determination unit 91 determines that the wheel loader 100 is in the vehicle resting state (YES in step S11), the resting state determination unit 91 instructs the calibration processing unit 92, and the calibration processing unit 92 executes the calibration processing (step S12). Accordingly, for example, the calibration work is automatically performed in a warm-up state after the start of the engine 31, and it is not necessary for the operator to perform the calibration work. Therefore, the braking characteristics of the brake can be secured without increasing the labor of the operator.

As illustrated in FIG. 11(B), in the manual calibration, for example, it is determined whether there is a calibration work command by the operator (step S10B). The calibration work command by the operator may be, for example, a case where the operator instructs the calibration work on a service menu of a monitor. In this determination, when there is no calibration work command by the operator, the determination of step S10A is repeated. On the other hand, in this determination, when it is determined that there is the calibration work command by the operator, the resting state determination unit 91 determines whether the wheel loader 100 is in the vehicle resting state (step S11). The subsequent steps in the manual calibration are the same as those in the automatic calibration, and thus the description thereof will not be repeated.

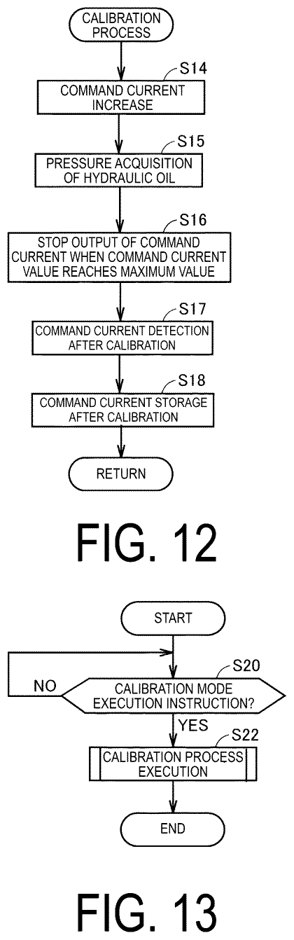

FIG. 12 is a subroutine flowchart of the calibration process by the calibration processing unit 92 according to the embodiment.

Referring to FIG. 12, the calibration processing unit 92 increases the command current to be output to the EPC valve 46 (step S14).

Next, the calibration processing unit 92 acquires the pressure of the hydraulic oil supplied to the shuttle valve unit 47 from the pressure sensor 75 (step S15).

Next, the calibration processing unit 92 stops the output of the command current to the EPC valve 46 when the command current value reaches the maximum value (step S16).

After the output of the command current to the EPC valve 46 is stopped in step S16, the calibration processing unit 92 detects the command current after calibration from the relationship between the command current value and the pressure of the hydraulic oil (step S17).

Next, the calibration processing unit 92 stores the detected command current values after the calibration (step S18).

Then, the calibration process is terminated (return). As a result, the process of the calibration mode is terminated.

By the above calibration process, even when the braking characteristics of the brake change due to deterioration over time or the like, it is possible to adjust the command current at which the pressure of the hydraulic oil supplied to the shuttle valve unit 47 becomes Ps (FIG. 10).

In this example, the wheel loader 100 automatically executes the calibration process of the command current when the wheel loader 100 is in the vehicle resting state. Thereby, it is possible to maintain the accuracy of the braking characteristics of the brake of the wet-type multi-plate disc structure.

Further, by setting the vehicle stop conditions of the work implement lock and the parking brake ON as the calibration conditions, it is possible to increase the frequency of the automatic calibration work based on the determination of the controller. As a result, the braking characteristics can be secured without increasing the time and effort of the operator.

FIG. 13 is a flowchart of another calibration mode of the wheel loader 100 according to an embodiment. As illustrated in FIG. 13, the calibration processing unit 92 determines whether there is an instruction to execute the calibration mode (step S20). When the calibration mode switch 57 is on, the calibration processing unit 92 determines that there is an instruction to execute the calibration mode.

Next, in step S20, when the calibration processing unit 92 determines that there is an instruction to execute the calibration mode (YES in step S20), the calibration processing unit 92 executes calibration processing (step S22). Details of the calibration process are the same as in the flow described with reference to FIG. 12.

Specifically, the calibration processing unit 92 increases the command current output to the EPC valve 46 and detects the command current at which the pressure of the hydraulic oil supplied to the shuttle valve unit 47 becomes Ps. The detected command current value is stored.

Then, the process of the calibration mode is terminated (END)

Through this process, the wheel loader 100 executes the command current calibration process when the operator operates the calibration mode switch 57 to turn on the calibration mode switch 57. Therefore, the operator can maintain the accuracy of the braking characteristic of the brake of the wet-type multi-plate disc structure at the intended timing.

### Other Embodiments

In the above-described embodiment, a HST32 is used as the drive device 21. Further, not only the HST but also an HMT (hydro mechanical transmission) may be used.

The wheel loader of the above embodiment may be operated by an operator on board, or may be operated in an unmanned manner.

In the above embodiment, the wheel loader has been described as an example of the work machine, but the work machine is not limited to the wheel loader and may be a hydraulic excavator or the like.

In the embodiment, the case where the automatic braking is executed when the presence of an object on the rear side is detected by the detection controller 180 at the time of backward movement has been described, but the invention of the present application can also be applied to a configuration in which the automatic braking is executed not only at the time of backward movement but also at the time of forward movement.

### APPENDICES

The above-described embodiments include the following technical ideas.

### Appendix 1

A work machine including:
a traveling body (2) configured to travel by power of a drive source (31);
brake circuits (42a, 42b) having a wet-type multi-plate disc structure configured to brake the traveling body;
a control valve (46a) configured to control an operation of the brake circuit; and
a controller (26) configured to output a command current for operating the control valve, wherein
the controller has a calibration mode for outputting the command current and calibrating the command current, and
the controller is configured to
determine whether the work machine is in a vehicle resting state and
execute the calibration mode when the work machine is in the vehicle resting state.

### Appendix 2

The work machine according to Appendix 1, including:
a parking brake(43); and
a work implement lock switch (56) configured to invalidate an operation signal of a work implement, wherein
the controller determines whether the work machine is in the vehicle resting state based on an operation state of the drive source, a state of the parking brake, and a state of the work implement lock switch.

### Appendix 3

The work machine according to Appendix 1 or 2, wherein
the controller has a manual calibration mode in which an operation instruction is received, the command current is output, and the command current is calibrated.

### Appendix 4

The work machine according to any one of Appendices 1 to 3, further including a sensor (75) configured to measure a hydraulic pressure when a hydraulic oil is supplied to the brake circuit, wherein
the controller increases a value of the command current and stores a current value when the hydraulic pressure of the sensor reaches a predetermined value.

### Appendix 5

The work machine according to any one of Appendices 1 to 4, further including an object sensor (25a) configured to detect an object around the traveling body, wherein
the controller outputs the command current based on a detection result of the object detection sensor in a case other than the calibration mode.

### Appendix 6

The work machine according to any one of Appendices 1 to 5, wherein
the controller determines whether the work machine is in the vehicle resting state based on a calibration work command issued from the controller or a calibration work command input by an operator.

### Appendix 7

The work machine according to Appendix 6, wherein
the controller issues the calibration work command based on a determination result of whether a frequency of use in the work machine is high or low.

### Appendix 8

A control method for a work machine, including
a step of determining (S10) whether the work machine is in a vehicle resting state;
a step of increasing (S14) a command current output to a control valve (43) configured to control an operation of brake circuit (42a, 42b) having a wet-type multi-plate disc structure configured to brake a traveling body (2) when the work machine is in the vehicle resting state;
a step of acquiring (S15) a pressure of a hydraulic oil supplied to the brake circuit;
a step of determining (S16) whether the pressure of the hydraulic oil reaches a predetermined value based on an acquisition result; and
a step of storing (S18) the command current when the pressure of the hydraulic oil reaches a predetermined value.

While certain embodiments have been described, these embodiments have been presented by way of example only, and are not intended to limit the scope of the present disclosure. The scope of the present disclosure is defined by the appended claims, and is intended to include any modifications within the meaning and scope equivalent to the claims.

### REFERENCE SIGNS LIST

1 Vehicle body, 2 Traveling body, 3 Work implement, 4 Front tire, 5 Cab, 5s Operator seat, 6 Engine room, 7 Rear tire, 9 Steering cylinder, 10 Vehicle body frame, 11 Front frame, 12 Rear frame, 13 Coupling shaft portion, 14 Boom, 15 Bucket, 16 Lift cylinder, 17 Bucket cylinder, 18 Bell crank, 21 Drive device, 22 Braking device, 23 Operation device, 24 Operation unit, 25 Detection device, 25a Object sensor, 26 Controller, 31 Engine, 40 Braking unit, 41 Brake valve unit, 41a Rear brake valve, 41b Front brake valve, 42a, 42b Brake circuit, 43 Parking brake, 44a, 44b Hydraulic oil supply passage, 45 Shut-off valve, 46, 62 EPC valve, 46a Return spring, 47 Shuttle valve unit, 47a Rear shuttle valve, 47b Front shuttle valve, 48 Tank, 49a, 49b Accumulator, 51 Work implement operation unit, 52 Traveling direction switching device, 53 Parking switch, 54 Brake pedal, 55 Accelerator, 56 Work implement lock switch, 57 Calibration mode switch, 61 Hydraulic pump, 74 Engine controller, 75 Pressure sensor, 90 Vehicle body controller, 91 Resting state determination unit, 92 Calibration processing unit, 94 EPC valve control unit, 100 Wheel loader, 180 Detection controller, 181 Object information acquisition unit, 182 Object determination unit.

1. A work machine comprising:
a traveling body configured to travel by power of a drive source;
a brake circuit having a wet-type multi-plate disc structure configured to brake the traveling body;
a control valve configured to control an operation of the brake circuit; and
a controller configured to output a command current for operating the control valve, wherein
the controller has a calibration mode for outputting the command current and calibrating the command current, and
the controller is configured to
determine whether the work machine is in a vehicle resting state and
execute the calibration mode when the work machine is in the vehicle resting state.

2. The work machine according to claim 1, comprising:
a parking brake; and
a work implement lock switch configured to invalidate an operation signal of a work implement, wherein
the controller determines whether the work machine is in the vehicle resting state based on an operation state of the drive source, a state of the parking brake, and a state of the work implement lock switch.

3. The work machine according to claim 1, wherein
the controller has a manual calibration mode in which an operation instruction is received, the command current is output, and the command current is calibrated.

4. The work machine according to claim 1, further comprising a sensor configured to measure a hydraulic pressure when a hydraulic oil is supplied to the brake circuit, wherein
the controller increases a value of the command current and stores a current value when the hydraulic pressure of the sensor reaches a predetermined value.

5. The work machine according to claim 1, further comprising an object sensor configured to detect an object around the traveling body, wherein
the controller outputs the command current based on a detection result of the object sensor in a case other than the calibration mode.

6. The work machine according to claim 1, wherein
the controller determines whether the work machine is in the vehicle resting state based on a calibration work command issued from the controller or a calibration work command input by an operator.

7. The work machine according to claim 6, wherein
the controller issues the calibration work command based on a determination result of whether a frequency of use in the work machine is high or low.

8. A control method for a work machine, comprising
determining whether the work machine is in a vehicle resting state;
increasing a command current output to a control valve configured to control an operation of a brake circuit having a wet-type multi-plate disc structure configured to brake a traveling body when the work machine is in the vehicle resting state;
acquiring a pressure of a hydraulic oil supplied to the brake circuit;
determining whether the pressure of the hydraulic oil reaches a predetermined value based on an acquisition result; and
storing the command current when the pressure of the hydraulic oil reaches a predetermined value.
